(19) United States
(12) Patent Application Publication
(10) Pub. No.: US 2010/0044534 A1
(43) Pub. Date: Feb. 25, 2010

(54) RESIZABLE DEVICE STAND

(75) Inventors: Meng-Hua He, Shenzhen City (CN); Gang Cheng, Shenzhen City (CN); Chun-Che Yen, Tu-Cheng (TW); Yu-Tao Chen, Tu-Cheng (TW); Te-Sheng Jan, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/427,708

(22) Filed: Apr. 21, 2009

(30) Foreign Application Priority Data
Aug. 22, 2008 (CN) 200810304149.3

(51) Int. Cl. F16M 11/20

(52) U.S. Cl. 248/188.8

(57) ABSTRACT

A stand includes a suction base and a load-supporting module mounted on the suction base. The load-supporting module includes a housing to house a pair of clamps, a gear, and a locking structure. The house defines a groove therein. Each clamp includes a vertical part and a horizontal part. The horizontal part includes a rack gear, and is received by the groove. The vertical parts are positioned upwardly from opposite sides of the housing respectively. The gear is rotatably mounted in the housing and meshes with the rack gears respectively. The locking structure is used for locking or unlocking the clamps. The stand is adapted for supporting different types and sizes of devices.

### BACKGROUND

1. Technical Field

The present disclosure relates to a device stand.

2. Description of Related Art

A motor vehicle may be used by different drivers who each have their mobile device they would like it to be supported by a stand in the vehicle, or a single driver may used different devices at different times. Because stands are usually adapted for a specific device type and size, many different stands must be available in the vehicle, which can be unsightly and waste space.

What is needed is a resizable stand adapted for supporting different types and sizes of devices.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a stand according to an exemplary embodiment, the stand including a suction base and a load-supporting module.

FIG. 2 is a exploded view of the load-supporting module of FIG. 1.

FIG. 3 is a top plan view of the load-supporting module of FIG. 1, with a top cover removed.

FIG. 4 is a schematic, isometric view of the suction base of FIG. 1.

FIG. 5 is an exploded view of the suction base of FIG. 4.

FIG. 6 is a section view of the suction base of FIG. 4 without a vacuum seal created.

FIG. 7 is a section view of the suction base of FIG. 4 with a vacuum seal created.

### DETAILED DESCRIPTION

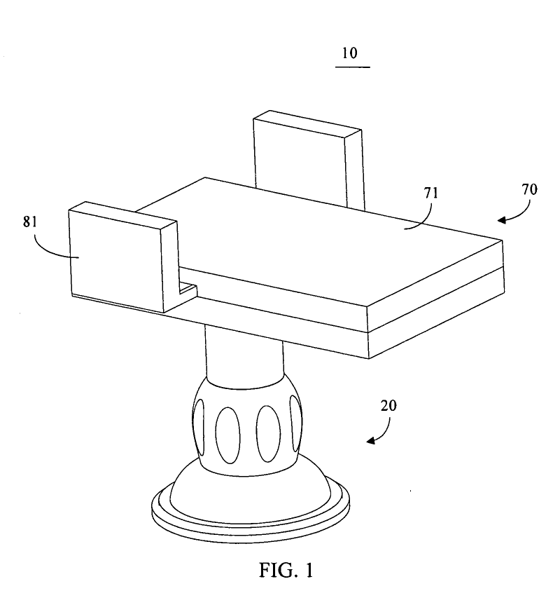

Referring to FIG. 1, a stand 10 according to an exemplary embodiment is disclosed. The stand 10 includes a suction base 20 and a load-supporting module 70 mounted on a top of the suction base 20.

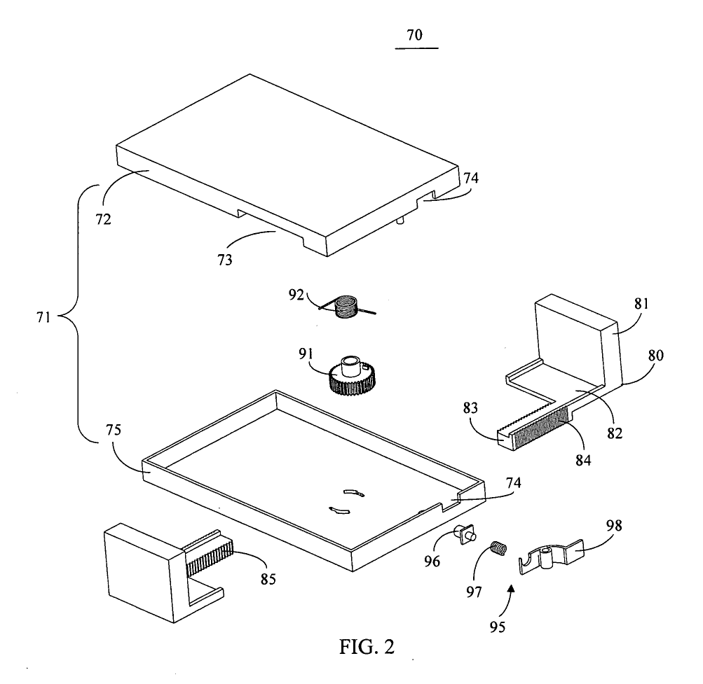

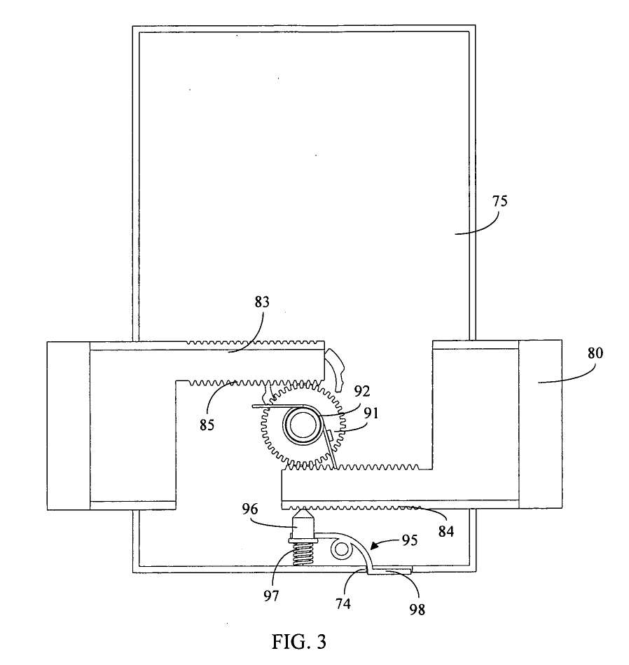

Referring to FIGS. 2 and 3, the load-supporting module 70 includes a housing 71. The housing 71 is rectangular, and includes a top cover 72 and a bottom cover 75. The top cover 72 defines a groove 73 therein. The housing 71 is configured to house a pair of clamps 80, a gear 91, a torsion spring 92, and a locking structure 95.

Each of the clamps 80 is L-shaped, and includes a vertical part 81 and a horizontal part 82. The horizontal part 82 includes a rack gear 83. The rack gear 83 defines a plurality of locking grooves 84 on outer sidewalls thereof. The horizontal part 82 is received by the groove 73 of the top cover 72. Referring to FIG. 1, the vertical parts 81 are positioned upwardly from the opposite sites of the housing 71.

The gear 91 is rotatably mounted in the housing 71 and meshes with the rack gears 83. The torsion spring 92 fits over a shaft of the gear 91. The torsion spring 92 causes the gear 91 to rotate, and causes the clamps 80 meshing with the gear 91 to move away from each other.

The locking structure 95 is used to lock the clamps 80 to fix the clamps 80 at a position, or to unlock the clamps 80 to allow the clamps 80 to move.

In the exemplary embodiment, the locking structure 95 includes a locking pin 96, a spring 97, and an elastic piece 98. The locking pin 96 is slidably mounted in the housing 71. The spring 97 fits over the locking pin 96 and causes the locking pin 96 to engage with a locking groove 84 in one of the clamps 80 to lock the clamps 80. The elastic piece 98 is rotatably mounted in the housing 71. One end of the elastic piece 98 is fixed to the locking pin 96. The other end of the elastic piece 98 stays in an opening 74 of the housing 71. When the elastic piece 98 is pressed at the end in the opening 74, the elastic piece 98 disengages the locking pin 96 from the locking groove 84, thus unlocking the clamps 80.

In other embodiments, the locking structure 95 can be a wedge slideably mounted in the housing 71. The wedge can plug into gaps between teeth of the gear 91, thus locking the gear 91 and the clamps 80, or move away from the gear 91, thus unlocking the gear 91 and the clamps 80.

Referring also to FIG. 1, when loading, a device (not shown) is placed on the housing 71. The clamps 80 are pushed to move towards each other and to clamp the device. The locking structure 95 locks the clamps 80. In this way, the device is fixed on the load-supporting module 70. The distance between the clamps 80 can be varied for clamping different sized devices. When unloading a device, the elastic piece 98 of the locking structure 95 is pressed down and the clamps 80 are unlocked. The torsion spring 92 causes the clamps 80 to move away from each other. Then, the device can be unloaded from the load-supporting module 70.

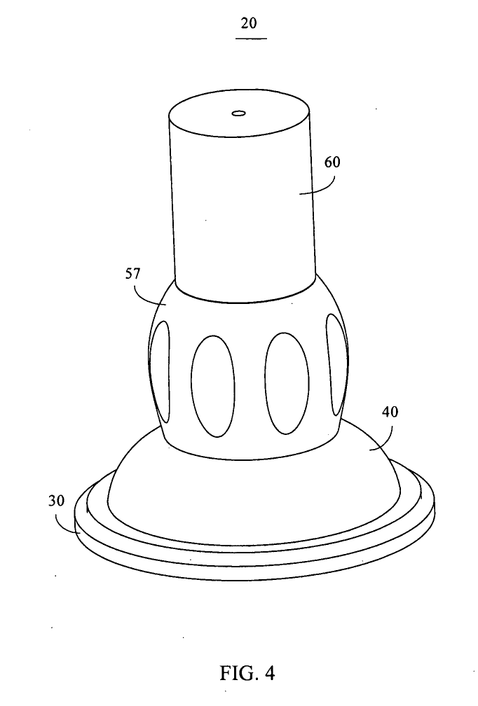

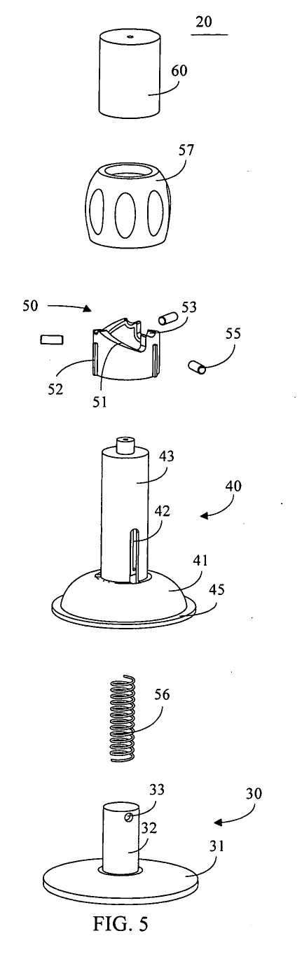

Referring to FIGS. 4, 5 and 6, the suction base 20 includes a suction piece 30, a spring 56, a fixing structure 40 for fitting over the suction piece 30, pins 55, a face cam 50, a rotatable sleeve 57, and a fixing cap 60.

The suction piece 30 includes a membrane 31 and a shaft 32 extending upwardly from the membrane 31.

The fixing structure 40 includes a shaft housing 41 and a sleeve 43 extending upwardly from the shaft housing 41, and lower edge of the housing 41 forms a flange 45. The sleeve 43 defines axial running slots 42. An upper end of the sleeve 43 is closed.

The face cam 50 is ring-shaped and has a face 51 which includes grooves 53 defined therein. The face cam 50 further includes axial rails 52 projected from an outer circumferential surface thereof.

During assembly of the suction base 20, first, the sleeve 43 receives the spring 56, then is fit over the shaft 32. The spring 56 is positioned between the upper end of the sleeve 43 and the shaft 32. Second, the face cam 50 is fit over the sleeve 43. One end of each of the pins 55 engages with the face 51 of the face cam 55. The other end of each of the pins 55 extends through the running slots 42 defined in the sleeve 43 and enters into holes 33 defined in the shaft 32. Third, the rotatable sleeve 57 fits over the face cam 50, and grooves (not shown) defined in an inner surface of the rotatable sleeve 57 engage with the rails 52 of the face cam 50, thus to connect the rotatable sleeve 57 to the face cam 50. Finally, the fixing cap 60 is fixed to the upper end of the sleeve 43 by screws (not shown).

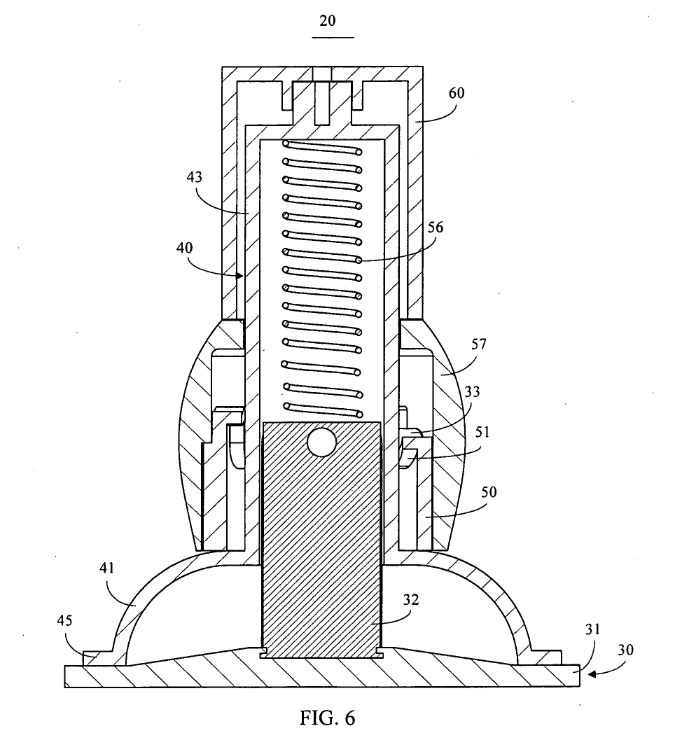

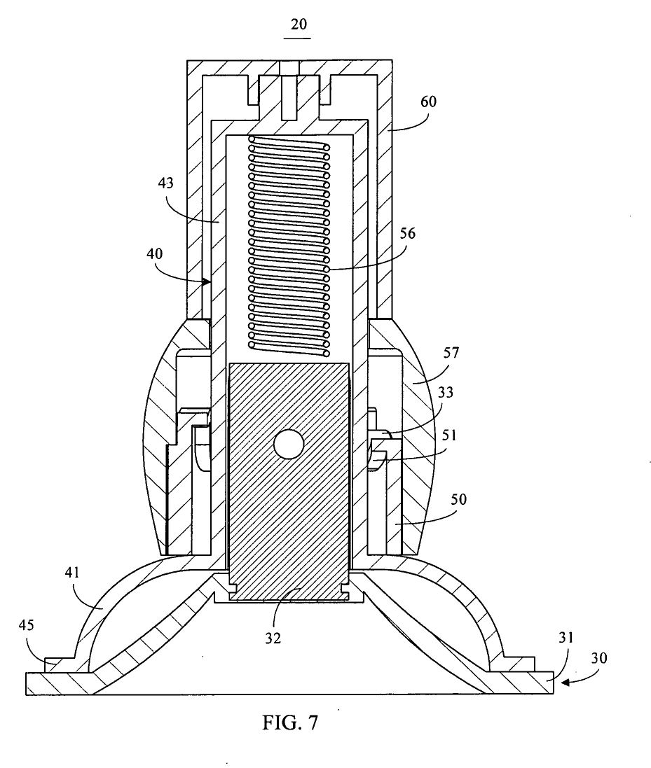

Referring to FIGS. 6 and 7, in use, the suction base 20 is put on a flat surface, so as to ensure the membrane 31 is flush against the surface, and the pins 55 are initially at a lowest position on the face 51. Then, the rotatable sleeve 57 is grasped and rotated, while holding the base 20 against the surface. During rotation of the sleeve 57, which causes the face cam 50 to rotate, the pins 55 are driven along the face 51 until engaging in the grooves 53. Meanwhile, the shaft 32, driven to move up by the pins 55, pulls only a central portion of the membrane 31 away from the contacting surface, as the edge of the membrane 31 is limited by the flange 45 of the shaft housing 41, thereby forming a vacuum seal between the membrane 31 and the contact surface. In this way, the suction base 20 is fixed on the surface.

The suction base 20 can be easily removed from the flat surface by rotating the rotatable sleeve 57. In this way, the membrane 31 is driven to move down, the vacuum between the membrane 31 and the surface of the flat surface is eliminated, and the suction base 20 is no longer fixed on the flat surface.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A resizable device stand comprising:
a suction base; and
a load-supporting module mounted on the suction base, the load-supporting module comprising:
a housing defining a groove therein;
a pair of clamps, each clamp comprising a vertical part and a horizontal part, wherein the horizontal part comprises a rack gear, and is received by the groove, the vertical parts being positioned upwardly from opposite sides of the housing, respectively;
a gear rotatably mounted in the housing and meshing with the rack gears of the clamps, respectively; and
a locking structure for locking or unlocking the clamps.

2. The stand of claim 1, further comprising a torsion spring configured for causing the gear to rotate, and thus for causing the clamps to move away from each other.

3. The stand of claim 2, wherein the torsion spring is fit over a shaft of the gear.

4. The stand of claim 1, wherein the rack gear define a plurality of locking grooves, the locking structure comprises a locking pin, a spring for causing the locking pin engage with the locking grooves of the rack gear, and an elastic piece configured for causing the locking pin to move away from the locking grooves when received a pressure.

5. The stand of claim 1, wherein the locking structure is a wedge slideably mounted in the housing, the wedge is able to plug into gaps between teeth of the gear or move away from the gear.

6. The stand of claim 1, wherein the clamps are L-shaped.
